(19) United States
(12) Patent Application Publication
(10) Pub. No.: US 2026/0027682 A1
(43) Pub. Date: Jan. 29, 2026

(54) AIR HAMMER ASSISTED REMOVAL OF FUEL INJECTOR

(71) Applicant: Milton Industries, Inc., Chicago, IL (US)

(72) Inventor: Jeffrey Del Rossa, Pittsburgh, PA (US)

(21) Appl. No.: 19/249,122

(22) Filed: Jun. 25, 2025

Related U.S. Application Data
(60) Provisional application No. 63/675,474, filed on Jul. 25, 2024.

(51) Int. Cl. B25B 27/02; B25B 27/00; F02M 61/16

(52) U.S. Cl. CPC B25B 27/026; F02M 61/168; B25B 27/0035

(57) ABSTRACT

Embodiments relate to methods of removing a fuel injector secured to an engine, and particularly to air hammer assisted methods of removing a fuel injector secured to an engine. In one embodiment, a method of using a fuel injector removal assembly comprising a fuel injector attachment adapter, an elongated shaft, and an air hammer may include coupling the fuel injector attachment adapter to a fuel injector, coupling a first end of the elongated shaft to the fuel injector attachment adapter, coupling the air hammer to a second end of the elongated shaft, and actuating the air hammer. The elongated shaft and the fuel injector attachment adapter may be configured to allow for accelerated coupling and decoupling.

### CROSS-REFERENCE TO RELATED APPLICATIONS

This application claims priority to U.S. Provisional Application No. 63/675,474, which was filed on Jul. 25, 2024. The entirety of this application is incorporated by reference herein.

### FIELD OF THE INVENTION

Embodiments relate to methods of removing a fuel injector secured to an engine, and particularly to air hammer assisted methods of removing a fuel injector secured to an engine.

### BACKGROUND OF THE INVENTION

Fuel injectors are often subjected to engine temperatures that can become elevated due to various vehicle applications, such as towing, high elevations, and high ambient temperatures. Fuel injectors may therefore get stuck and be difficult to remove in order to be serviced or replaced. For example, polymeric “O” ring seals often harden relative to age and application duty cycles and make removal of a fuel injector difficult. Other factors, such as build-up, corrosion, reaction between metals, etc., may further contribute to the difficulty in removing fuel injectors.

One technique used to remove fuel injectors from engines is a sliding ring collet. A ring collet usually consists of small fingers that are placed around a portion of the fuel injector to be extracted, such that when the collet ring is pushed down, the collet (or fingers) exerts a clamping force on the object. Due to the limited and small surface area at which the small fingers engage with the injector, the injector becomes damaged and unusable. Moreover, this technique can be ineffective when used on difficult to remove fuel injectors. Other techniques may use mechanisms that are complex and/or bulky, but when operating in a compromised space (e.g., within an engine), such techniques may be impractical or require a time-consuming engine removal process.

### SUMMARY OF THE INVENTION

The presently disclosed methods describe processes to extract difficult to remove fuel injectors from an engine. The processes utilize an air hammer to engage a fuel injector. By engaging a fuel injector with an air hammer, it is possible to transfer both forces of the air hammer-impact (push) and extraction (pull) force—to the fuel injector. The combination of the two forces provide longitudinal (tensile) force and vibrations to “shock” the bond between the fuel injector and cylinder head, thus dislodging it from the engine. Embodiments of the presently disclosed methods are advantageous, as they enable an extraction process that may otherwise require more complex mechanisms and removal of the engine. Embodiments may further enable removal of the fuel injector from the engine without damaging the fuel injector itself.

In an exemplary method of using a fuel injector removal assembly, wherein the assembly comprises a fuel injector attachment adapter, an elongated shaft, and an air hammer, the method comprises coupling the fuel injector attachment adapter to a fuel injector; coupling a first end of the elongated shaft to the fuel injector attachment adapter; coupling the air hammer to a second end of the elongated shaft; and actuating the air hammer.

In some embodiments, the fuel injector attachment adapter has a first face and a second face, wherein the first face has a first aperture and the second face has a second aperture.

In some embodiments, the first aperture is threaded, and wherein the step of coupling the fuel injector attachment adapter to the fuel injector involves inserting a threaded portion of the fuel injector into the first aperture of the fuel injector attachment adapter.

In some embodiments, the second aperture is threaded and the first end of the elongated shaft comprises a threaded portion, and wherein the step of coupling the first end of the elongated shaft to the fuel injector attachment adapter involves inserting the threaded portion of the elongated shaft into the second aperture of the fuel injector attachment adapter.

In some embodiments, the first end of the elongated shaft comprises a drive and the second aperture of the fuel injector attachment adapter comprises a complementary opening, and wherein the step of coupling the first end of the elongated shaft to the fuel injector attachment adapter involves inserting the drive of the elongated shaft into the second aperture of the fuel injector attachment adapter.

In some embodiments, the elongated shaft further comprises a detent ball configured to be received by an aperture in a sidewall of the fuel injector attachment adapter to secure the elongated shaft to the fuel injector attachment adapter.

In some embodiments, the elongated shaft further comprises a release collar axially slidable relative to the elongated shaft, wherein the release collar is configured to release the elongated shaft from the fuel injector attachment adapter when retracted.

In some embodiments, the fuel injector attachment adapter has a first face and a second face, wherein a protrusion extends from the first face and the second face has an aperture.

In some embodiments, the protrusion has a threaded portion, and wherein the step of coupling the fuel injector attachment adapter to the fuel injector involves inserting the protrusion into a complementary threaded portion of the fuel injector.

In some embodiments, the aperture is threaded and the first end of the elongated shaft comprises a threaded portion, and wherein the step of coupling the first end of the elongated shaft to the fuel injector attachment adapter involves inserting the threaded portion of the elongated shaft into the aperture of the fuel injector attachment adapter.

In some embodiments, the air hammer is a bi-directional air hammer.

In an exemplary method of using a fuel injector removal assembly, wherein the assembly comprises a striking member, a struck piece, and an air hammer, the method comprises coupling the struck piece to a fuel injector; coupling a first end of the striking rod to the air hammer; and actuating the air hammer such that a second end of the striking rod is driven against the struck piece.

In some embodiments, the struck piece comprises a body having a first end and a second end; an aperture formed at the first end; and a base attached to the second end of the body.

In some embodiments, the aperture is threaded, and wherein the step of coupling the struck piece to the fuel injector involves inserting a threaded portion of the fuel injector into the aperture of the struck piece.

In some embodiments, the base extends radially outward such that the base has a greater diameter than the body, and wherein the base has a plurality of indents, and wherein the step of actuating the air hammer such that the second end of the striking rod is driven against the struck piece involves driving the second end of the striking rod into the indents of the base.

In some embodiments, the air hammer is a bi-directional air hammer.

In an exemplary method of using a fuel injector removal assembly, wherein the assembly comprises a striking member, a struck piece, an elongated shaft, and an air hammer, the method comprises coupling the struck piece to a first end of the elongated shaft; coupling a second end of the elongated shaft to a fuel injector; coupling a first end of the striking rod to the air hammer; and actuating the air hammer such that a second end of the striking rod is driven against the struck piece.

In some embodiments, the struck piece comprises a body and an aperture formed in the body, wherein the step of coupling the struck piece to the first end of the elongated shaft involves inserting a portion of the elongated shaft into the aperture of the struck piece.

In some embodiments, the body has at least one groove formed therein, and wherein the step of actuating the air hammer such that the second end of the striking rod is driven against the struck piece involves driving the second end of the striking rod into the at least one groove.

In some embodiments, the air hammer is a bi-directional air hammer.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows a front view of an exemplary fuel injector according to known art.

FIG. 2 shows a perspective view of an exemplary air hammer assisted method of removing a fuel injector secured to an engine.

FIG. 3 shows a first embodiment of an exemplary fuel injector removal assembly.

FIGS. 4A-4B show exemplary embodiments of an elongated shaft according to disclosed embodiments.

FIG. 5 shows an exemplary embodiment of a fuel injector removal adapter according to disclosed embodiments.

FIG. 6 shows a second embodiment of an exemplary fuel injector removal assembly.

FIG. 7 shows an exemplary embodiment of an elongated shaft configured for accelerated attachment and detachment according to disclosed embodiments.

FIG. 8 shows an exploded view of an exemplary embodiment of an elongated shaft configured for accelerated attachment and detachment according to disclosed embodiments.

FIGS. 9A-9B show perspective views of exemplary embodiments of a fuel injector attachment adapter according to disclosed embodiments.

FIGS. 10A-10B show perspective views of exemplary embodiments of a fuel injector attachment adapter according to disclosed embodiments.

FIG. 11A shows a perspective view of an exemplary embodiment of a fuel injector attachment adapter configured for accelerated attachment and detachment according to disclosed embodiments.

FIG. 11B shows a cross section view of an exemplary embodiment of a fuel injector attachment adapter configured for accelerated attachment and detachment according to disclosed embodiments.

FIG. 12 shows perspective and cross section views of an exemplary embodiment of a fuel injector attachment adapter configured for accelerated attachment and detachment according to disclosed embodiments.

FIG. 13 shows a third embodiment of an exemplary fuel injector removal assembly.

FIG. 14 shows a fourth embodiment of an exemplary fuel injector removal assembly.

FIG. 15 shows a fifth embodiment of an exemplary fuel injector removal assembly.

FIG. 16 shows an exemplary embodiment of a struck piece according to disclosed embodiments.

FIG. 17 shows a fifth embodiment of an exemplary fuel injector removal assembly.

FIG. 18 shows an exemplary embodiment of a struck piece according to disclosed embodiments.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

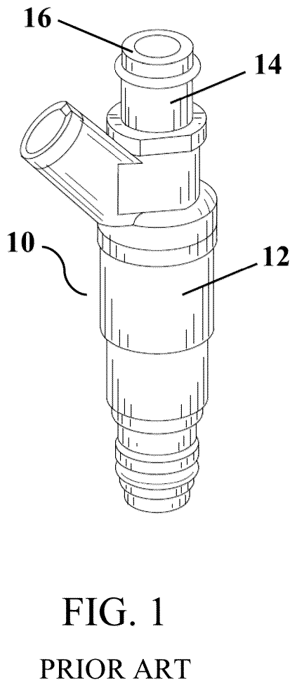

Embodiments relate to methods and processes of removing a fuel injector 10 from an engine. As seen in FIG. 1, a fuel injector 10 typically consists of a generally cylindrical body 12 with at least one stem-like member 14 protruding from the body 12. A member 14 may be topped with a spherical, hemispherical, or prismatic knob-like member 16. It is contemplated that the member 16 may comprise a threaded portion (e.g., external or male threads) such that an apparatus with complementary threads may be removably coupled to the member 16.

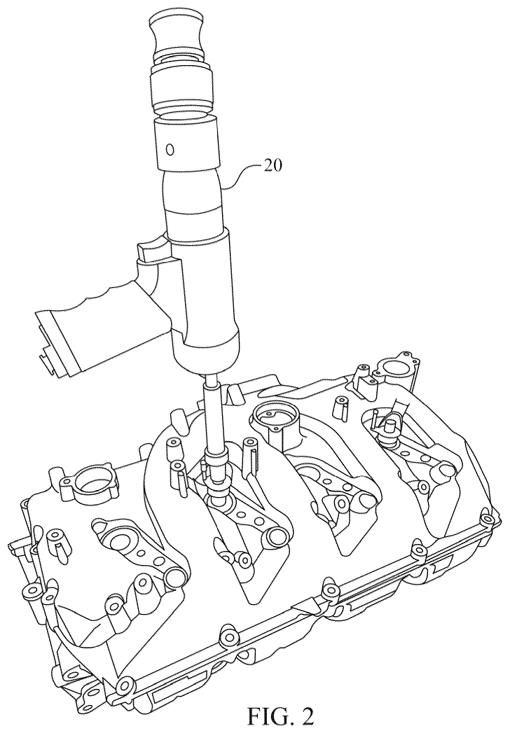

Embodiments particularly relate to air hammer 20 assisted methods and processes (see FIG. 2). Air hammers (or pneumatic hammers) are a pneumatic hand tool well-known in the art. Air hammers typically use compressed air to drive or punch a bit and are often used to carve into objects, break objects apart, etc. While some air hammers are unidirectional and only deliver a driving or punching force, bi-directional air hammers deliver both an impact (push) and extraction (pull) force. Accordingly, an air hammer, preferably a bi-directional air hammer, may be useful in various embodiments to extract a difficult to remove fuel injector from an engine. For example, as seen in FIG. 2, an air hammer 20 may indirectly engage a fuel injector, and the forces exerted by the air hammer may be transferred to the fuel injector, thus vibrating it loose from the engine.

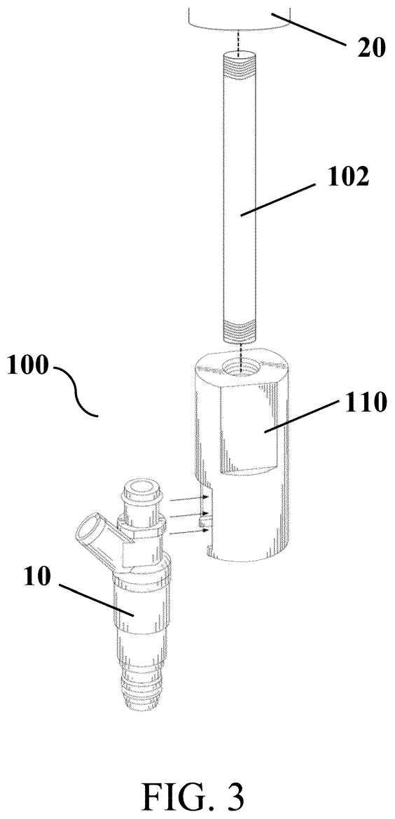

In a first embodiment, a first fuel injector removal assembly 100 is configured to remove a fuel injector 10 from an engine. As seen in FIG. 3, assembly 100 comprises an elongated shaft 102 removably coupled to a fuel injector removal adapter 110. The fuel injector removal adapter 110 is configured to receive and engage the fuel injector 10, and the elongated shaft 102 is configured to removably couple to the air hammer 20, such that the air hammer 20 is in indirect contact with the fuel injector 10.

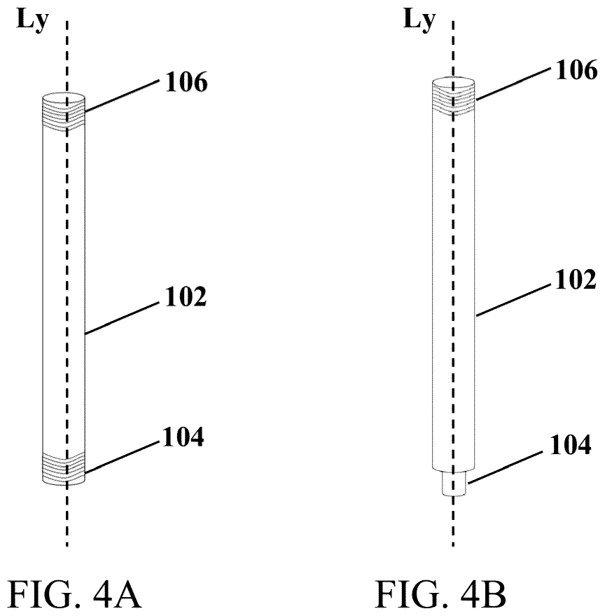

As seen in FIGS. 4A and 4B, the elongated shaft 102 is a rigid material (e.g., metal, metal alloy, plastic, polymer, ceramic, composite material, etc.) with a longitudinal axis Ly running from a first end 104 to a second end 106. It is contemplated for the elongated shaft 102 to be cylindrical in shape with a circular cross-section when viewed along the longitudinal axis Ly. Other cross-sectional shapes can be used, such as triangular, square, hexagonal, etc. Each of the first end 104 and the second end 106 is shown to form a planar terminus, but any one or combination of the ends 104, 106 need not be planar in shape.

The second end 106 of the elongated shaft 102 is configured to removably couple to the air hammer 20. The second end 106 may comprise a threaded portion with external threads. It is contemplated that the threaded portion of the second end 106 may complement threads (e.g., internal or female threads) of a threaded aperture of the air hammer 20 to removably couple the elongated shaft 102 to the air hammer 20. In some embodiments, the elongated shaft 102 may have a protrusion at its second end 106, and the protrusion may have a threaded portion. For example, the protrusion may be smaller in diameter/width and have a threaded portion to complement threads of a threaded aperture of the air hammer 20. However, any one of the second end 106 of the elongated shaft 102 or the aperture of the air hammer 20 can have a locking-pin, detent, magnet, or any other suitable coupling mechanism to secure the elongated shaft 102 to the air hammer 20.

Another option is for the aperture to be an opening configured to receive a complementary drive (e.g., square drive, hexagonal drive, etc.) of the second end 106. The drive may be any size, including a quarter-inch drive, a half-inch drive, an inch drive, etc.

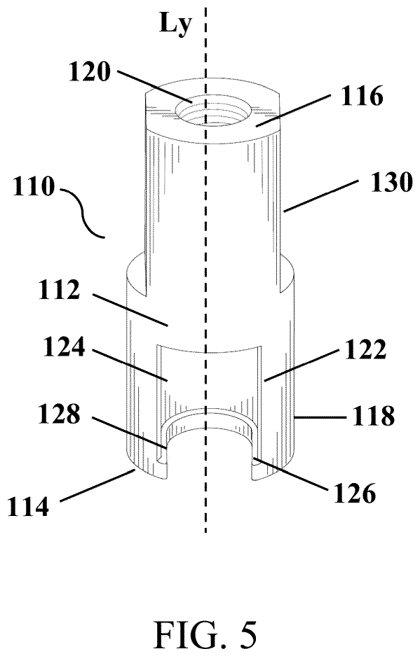

The first end 104 of the elongated shaft 102 is configured to removably couple to the fuel injector removal adapter 110. As seen in FIG. 4A, the first end 104 may also comprise a threaded portion with external threads. It is contemplated that the threaded portion of the first end 104 may complement internal threads of a threaded aperture 120 (see FIG. 5) of the fuel injector removal adapter 110 to removably couple the elongated shaft 102 to the fuel injector removal adapter 110. In some embodiments, the elongated shaft 102 may have a protrusion at its first end 104, and the protrusion may have a threaded portion. For example, the protrusion may be smaller in diameter/width and have a threaded portion to complement threads of a threaded aperture of the fuel injector removal adapter 110.

The first end 104 may alternatively comprise a drive configured to be received by a complementary aperture 120 of the fuel injector removal adapter 110 to removably couple the elongated shaft 102 to the fuel injector removal adapter 110 (see FIG. 4B). It is contemplated that the drive may be any shape, such as square, hexagonal, etc. The drive may be any size, including a quarter-inch drive, a half-inch drive, an inch drive, etc.

Regardless of the coupling mechanism, the elongated shaft 102 may indirectly couple the air hammer 20 to the fuel injector removal adapter 110.

It is contemplated that the external and internal threads (e.g., threaded portions, threaded bore, threaded aperture) described above are used to provide an engagement or securement between threads.

As seen in FIG. 5, the fuel injector removal adapter 110 comprises a member 112 configured to receive the fuel injector 10. It is contemplated that the member 112 is a rigid material (e.g., metal, metal alloy, plastic, polymer, ceramic, composite material, etc.). The member 112 has a first face 114, a second face 116, and sidewalls 118. The member 112 has a longitudinal axis Ly running from the first face 114 to the second face 116. It is contemplated for the member 112 to be cylindrical in shape with a circular cross-section when viewed along the longitudinal axis Ly. Other cross-sectional shapes can be used, such as triangular, square, hexagonal, etc. Each of the first face 114 and the second face 116 is shown to form a planar terminus, but any one or combination of the faces 114, 116 need not be planar in shape.

The second face 116 can have an aperture 120. As described above, the aperture 120 may have internal threads that complement a threaded portion of the first end 104 of the elongated shaft 102 to removably couple the elongated shaft 102 to the fuel injector removal adapter 110. In an alternative embodiment, the aperture 120 may be shaped to complement a drive of the first end 104 of the elongated shaft 102 to removably couple the elongated shaft 102 to the fuel injector removal adapter 110. It is contemplated that this embodiment allows for a quick disconnect of the elongated shaft 102 from the fuel injector removal adapter 110. This embodiment may further comprise a locking collar (not shown), preferably at or near the first end 104 of the elongated shaft 102, to ensure securement between the elongated shaft 104 and the fuel injector removal adapter 110.

The member 112 comprises a fuel injector-receiving opening 122 and a pocket 124. The member 112 further comprises a cut-away portion 126 at or near the first face 114. The cut-away portion 126 extends from some area on the first face 114 through an edge of the first face 114. The cut-away portion 126 may be any shape, such as circular, triangular, square, hexagonal, etc., but is contemplated to complement the shape of a fuel injector 10, particularly the stem-like member 14 and/or knob-like member 16 of the fuel injector 10. The cut-away portion 126 can be generated via machining techniques to form a precision machined cut-away formation.

The fuel-injector receiving opening 122 is positioned on a side (e.g., within a sidewall 118) of the member 112 and is adjoined with the cut-away portion 126 on the first face 114. The fuel-injector receiving opening 122 may be any shape, such as circular, triangular, square, hexagonal, etc., but is contemplated to complement the shape of a fuel injector 10, particularly the stem-like member 14 and/or knob-like member 16 of the fuel injector 10. The width of the fuel-injector receiving opening 122 is configured to be greater than the width of the cut-away portion 126 in order to form a ridge 128. The ridge 128 extends radially inward, which means the ridge 128 extends from the perimeter of the first face 114 inward towards the center point of the cross-sectional shape of the member 112.

The pocket 124 is positioned within the member 112 and is adjoined with the fuel injector-receiving opening 122 and the cut-away portion 126. The pocket 124 may be any shape, such as circular, triangular, square, hexagonal, etc., but is contemplated to complement the shape of a fuel injector 10, particularly the stem-like member 14 and/or knob-like member 16 of the fuel injector 10. The pocket 124, the fuel injector-receiving opening 122, and the cut-away portion 126 can work in conjunction to house a fuel injector 10 when the fuel injector 10 is received by the fuel injector removal adapter 110. Once inserted, the fuel injector 10 can be engaged by the ridge 128 to prevent the fuel injector 10 from escaping the fuel injector removal adapter 110.

Once the elongated shaft 102 is coupled to the air hammer 20 and fuel injector removal adapter 110, and the fuel injector 10 is received by the fuel injector removal adapter 110, thereby indirectly coupling the air hammer 20 to the fuel injector 10, a user may operate the air hammer 20. Forces exerted by the air hammer 20 may be transferred to the fuel injector 10 (e.g., via elongated shaft 102 and fuel injector removal adapter 110). In a preferred embodiment, a bi-directional air hammer 20 is used to exert driving and pulling forces, which may be transferred to the fuel injector 10. It is contemplated that the fuel injector 10 may thereby be dislodged from the engine (e.g., via vibrational motion from the assembly 100).

It is contemplated that engagement of the fuel injector 10 via the ridge 128 of the fuel injector removal adapter 110 places most, if not all, of the pull force on the strongest part of the fuel injector 10. This configuration and engagement may prevent damage to the fuel injector 10 during removal.

As can be appreciated from the above disclosure, a preferred embodiment of the fuel injector removal adapter 110 comprises a member 112 with a first face 114, a second face 116, and sidewalls 118. At or near the first face 114 is a cut-away portion 126 that is machined into the sidewall 118. The cut-away portion 126 forms a bored out region within the member 112. This cut-away portion 126 not only complements a shape of a fuel injector 10, but the cut-away portion 126 is generated so that it forms a fuel-injector receiving opening 122 within the sidewall 118. Thus, member 112 includes sidewalls 128 having an inner sidewall surface and an outer sidewall surface. The cut-away portion 126 is defined by the inner sidewall surface, the ridge 128, and the pocket 124. The fuel-injector receiving opening 122 is an opening that complements a side profile of a fuel injector 10, or is an opening that is at least as wide as the fuel injector 10 so as to allow the fuel injector removal adapter 110 to receive the fuel injector 10 via lateral sliding motion (see FIG. 3). The cut-away portion 126 of the inner sidewall surface, the ridge 128, and the pocket 124 are precision cut to generate a precision fit with the fuel injector 10. The fuel injector 10 has members 14 and/or 16 that fit into the cut-away portion 126 via the fuel-injector receiving opening 122 and mechanically engages (e.g., abuts against) with the ridge 128 when the fuel injector removal adapter 110 is pulled from the front face 114 to the second face 116—i.e., the inner sidewall surface has an inner diameter that is equal to or greater than the outer diameter of members 14 and/or 16, but the ridge 128 has an inner diameter that is less than the outer diameter of members 14 and/or 16. While the fuel-injector receiving opening 122 is wider than that of the fuel injector 10 to allow for lateral sliding motion of the fuel injector 10 therein and therefrom, it is only slightly wider. This configuration allows for the inner sidewall surface to mechanically engage with or abut against an outer surface of the fuel injector 10. With this configuration, the fuel injector removal adapter 110 forms a defilade about the fuel injector 10—e.g., the inner sidewall surface surrounds and abuts against the fuel injector 10 outer surface about the circumference of the fuel injector 10 except at the fuel-injector receiving opening 122. With the fuel injector receiving opening 122 being only slightly wider than the fuel injector 10, the inner sidewall surface can generate up to 270 degrees of contact with the fuel injector 10 outer surface (or at least the fuel injector 10 outer surface portion that is within the adapter 110) when the fuel injector 10 is received by the adapter 110. This defilade architecture provides structural support to the fuel injector 10 and helps keep the fuel injector 10 in a straight position when forces are applied to remove the fuel injector 10. The ridge 128 and pocket 124 provide additional structural support and further assist with proper alignment of the fuel injector 10. Force vectors are transferred to the fuel injector 10 at members 14 and/or 16. The ridge 128 extends about the circumference of the inner sidewall surface, and thus the force(s) applied to the fuel injector 10 is/are spread about this entire ridge 128. This prevents or reduces high pressure points being applied to the fuel injector 10—high pressure points that tend to lead to damage of the fuel injector 10.

The member 112 can have at least one indent 130 formed in a sidewall 118. It is contemplated that the member 112 has a plurality of indents 130. The indents 130 can be positioned opposite of the first face 114 and can extend with the longitudinal axis Ly of the member 112, which means that the indents 130 run parallel with the longitudinal axis Ly of the member 112. The indents 130 can improve the fuel injector removal adapter's 110 efficiency in removably coupling to the elongated shaft 102. For instance, the indents 130 may provide for an ergonomic design that allows a user to grip the member 112 easily with fingers and/or hands.

In a second embodiment, a second fuel injector removal assembly 200 is configured to remove a fuel injector 10 from an engine. The second embodiment (e.g., second fuel injector removal assembly 200) may be similar to the first embodiment (e.g., first fuel injector removal assembly 100) such that only elements different from those of the first embodiment will be described in detail. Like elements (e.g., elements performing similar functions and/or of similar structure) will not be described in detail. Like elements in the first and second embodiments have been allocated the same reference numeral in the 100 and 200 series, respectively. For example, elongated shaft 102 and elongated shaft 202 are like elements such that the description relating to elongated shaft 102 applies to elongated shaft 202.

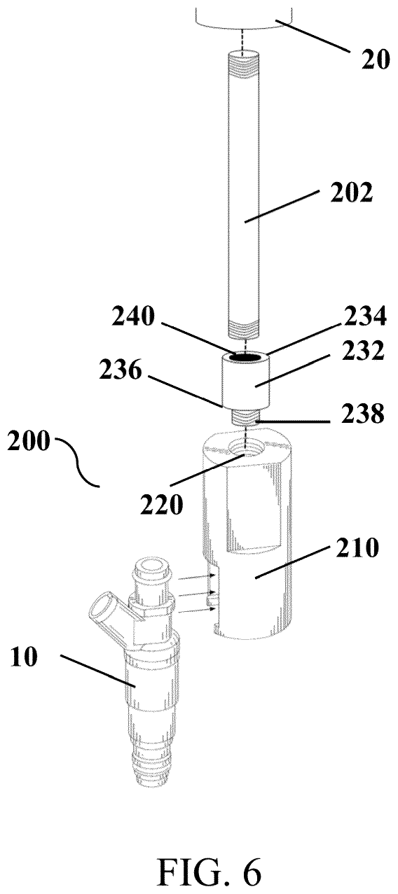

As seen in FIG. 6, the assembly 200 comprises an elongated shaft 202 removably coupled to a thread adapter 232, which is removably coupled to a fuel injector removal adapter 210. The fuel injector removal adapter 210 is configured to receive and engage the fuel injector 10, and the elongated shaft 202 is configured to removably couple to the air hammer 20, such that the air hammer 20 is in indirect contact with the fuel injector 10.

The thread adapter 232 is a rigid material (e.g., metal, metal alloy, plastic, polymer, ceramic, composite material, etc.) with a first face 234 and a second face 236. It is contemplated for the threaded adapter 232 to be generally cylindrical in shape with a circular cross-section. Other cross-sectional shapes can be used, such as triangular, square, hexagonal, etc. Each of the first face 234 and the second face 236 forms a planar terminus, but any one or combination of the faces 234, 236 need not be planar in shape.

As seen in FIG. 6, the thread adapter 232 comprises a protrusion 238 at the first face 236. The protrusion 238 extends in or substantially in the same direction of which the thread adapter 232 extends. The protrusion 238 may comprise a threaded portion with external threads. It is contemplated that the threaded portion of the protrusion 238 may complement internal threads of an aperture 220 of the fuel injector removal adapter 210 to removably couple the thread adapter 232 to the fuel injector removal adapter 210. The thread adapter 232 further comprises an aperture 240 at the second face 234. It is contemplated that the aperture 240 may have internal left-handed threads that complement a left-handed threaded portion of the elongated shaft 202. This orientation provides the ability to install elongated shaft 202 with thread adapter 232/aperture 240 without needing to remove elongated shaft 202 from air hammer 20. For example, a right-handed threaded portion of elongated shaft 202 combined with a left-handed threaded portion at the opposite end of elongated shaft allows the assembly to be pulled together simultaneously. Such embodiments may be advantageous when operating in a compromised space (e.g., within an engine), as the thread adapter 232 may allow for a user to more easily couple elements of the assembly 200.

It is contemplated that the external and internal threads (e.g., threaded portions, threaded aperture) described above are used to provide an engagement or securement between threads.

Once the elongated shaft 202 is coupled to the air hammer 20 and the thread adapter 232, the thread adapter is further coupled to the fuel injector removal adapter 210, and the fuel injector 10 is received by the fuel injector removal adapter 210 (as described in detail with respect to the first embodiment), thereby indirectly coupling the air hammer 20 to the fuel injector 10, a user may operate the air hammer 20. Forces exerted by the air hammer 20 may be transferred to the fuel injector 10 (e.g., via elongated shaft 202, thread adapter 232, and fuel injector removal adapter 210). In a preferred embodiment, a bi-directional air hammer 20 is used to exert pulling forces, which may be transferred to the fuel injector 10. It is contemplated that the fuel injector 10 may thereby be dislodged from the engine (e.g., via vibrational motion from the assembly 200).

In a third embodiment, a third fuel injector removal assembly 300 is configured to remove a fuel injector 10 from an engine. The third embodiment (e.g., third fuel injector removal assembly 300) may be similar to the first embodiment (e.g., first fuel injector removal assembly 100) such that only elements different from those of the first embodiment will be described in detail. Like elements (e.g., elements performing similar functions and/or of similar structure) will not be described in detail. For example, elongated shaft 102 and elongated shaft 302 are like elements such that the description relating to elongated shaft 102 applies to elongated shaft 302.

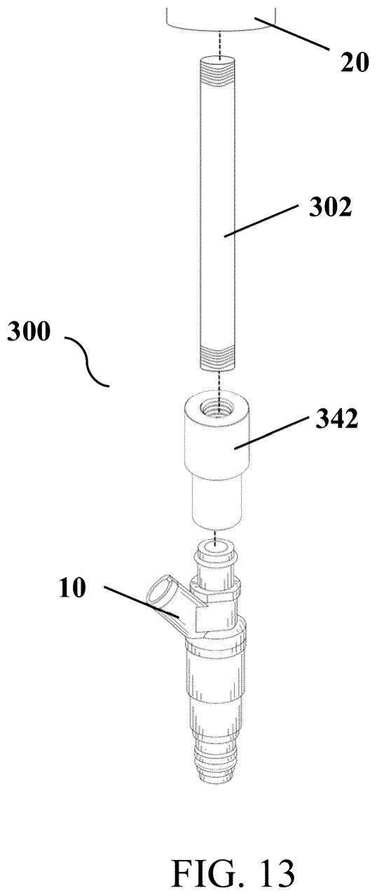

As seen in FIG. 13, the assembly 300 comprises an elongated shaft 302 removably coupled to a fuel injector attachment adapter 342, which is removably coupled to the fuel injector 10. The elongated shaft 302 is configured to removably couple to the air hammer 20, such that the air hammer 20 is in indirect contact with the fuel injector 10.

The fuel injector attachment adapter 342 has a body 344 (e.g., metal, metal alloy, plastic, polymer, ceramic, composite material, etc.) with a longitudinal axis Ly running from a first face 346 to a second face 348. It is contemplated for the body 344 to be cylindrical in shape with a circular cross-section when viewed along the longitudinal axis Ly. Other cross-sectional shapes can be used, such as triangular, square, hexagonal, etc. Each of the first face 344 and the second face 346 forms a planar terminus, but any one or combination of the faces 344, 346 need not be planar in shape.

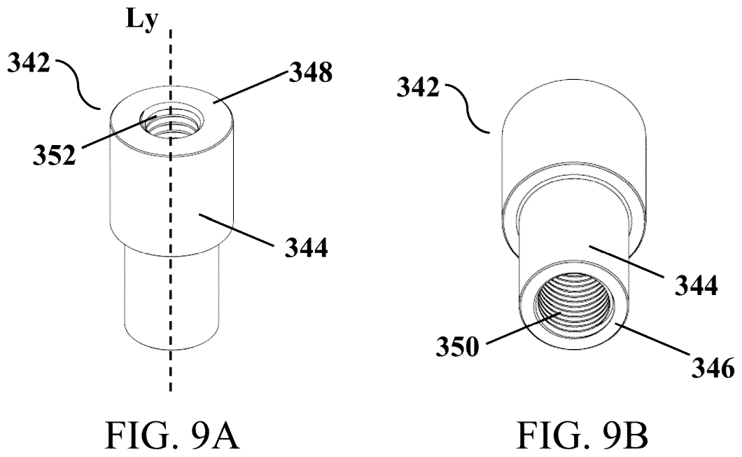

As seen in FIGS. 9A-11B, the fuel injector attachment adapter 342 may comprise a first aperture 350 at the first face 346. The first aperture 350 may be a bore hole formed within the first face 346, and may be configured to receive the fuel injector 10. As described above, the fuel injector 10, particularly knob-like member 16, may have a threaded portion (e.g., external or male threads) such that an apparatus with complementary threads may be removably coupled to the member 16. Accordingly, the first aperture 350 may have internal threads that complement a threaded portion of the fuel injector 10 such that the fuel injector attachment adapter 342 may be removably coupled to the fuel injector 10.

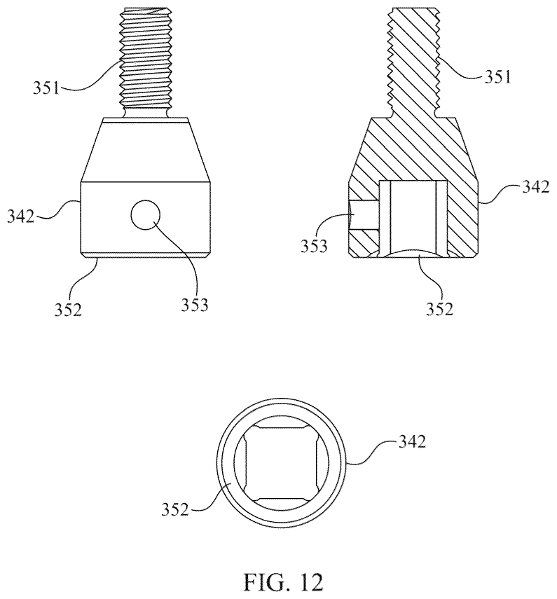

Alternative, as seen in FIG. 12, the fuel injector attachment adapter 342 may comprise a protrusion 351 at the first face 346. The protrusion 351 may extend from the fuel injector attachment adapter 342 and may also comprise a threaded portion with external threads. It is contemplated that the threaded portion of the protrusion 351 may complement internal threads of a fuel injector 10. As described further below, the fuel injector 10 may have threads (e.g., internal or female threads), for example, after being tapped such that an apparatus with complementary threads may be removably coupled to the member 16. Accordingly, the protrusion 351 may have external threads that complement a threaded portion of the fuel injector 10 such that the fuel injector attachment adapter 342 may be removably coupled to the fuel injector 10.

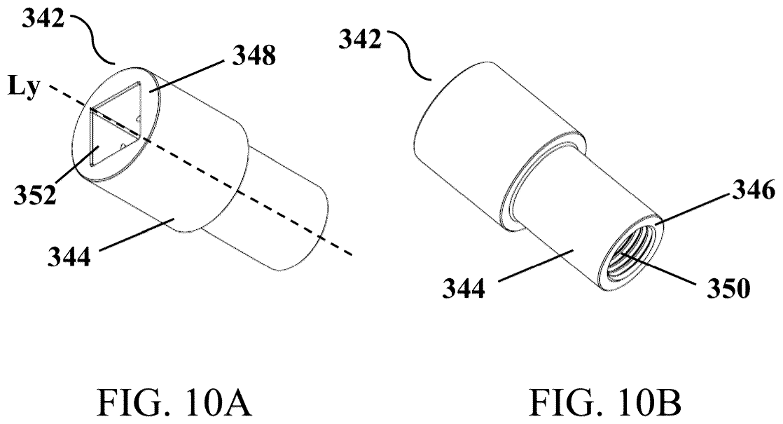

The fuel injector attachment adapter 342 may further comprise a second aperture 352 at the second face 348. The second aperture 352 may be a bore hole formed within the second face 348, and is configured to receive the elongated shaft 302. The second aperture 352 may have internal threads that complement a threaded portion of the elongated shaft 302 to removably couple the fuel injector attachment adapter 342 to the elongated shaft 302 (see FIGS. 9A and 9B). In an alternative embodiment, the second aperture 352 may be shaped to complement a drive (e.g., square drive, hexagonal drive, etc.) of the elongated shaft 302 to removably couple the elongated shaft 302 to the fuel injector attachment adapter 342 (see FIGS. 10A and 10B). The drive may be any size, including a quarter-inch drive, a half-inch drive, an inch drive, etc. As described in more detail below, it is contemplated that this embodiment may allow for a quick disconnect (e.g., accelerated attachment and detachment) of the elongated shaft 302 from the fuel injector attachment adapter 342.

It is further is contemplated that any one of the first end of the elongated shaft 302 or the second aperture 352 of the adapter 342 can have a locking-pin, detent, magnet, or other suitable coupling mechanism to secure the elongated shaft 310 to the adapter 342.

It is contemplated that the first aperture 350 and the second aperture 352 may be formed by a through hole extending throughout the body 344 of the fuel injector attachment adapter 342 (e.g., extending from the first face 346 to the second face 348).

Once the elongated shaft 302 is coupled to the air hammer 20 and the fuel injector attachment 342, and the fuel injector 10 is coupled to the fuel injector attachment adapter 342, thereby indirectly coupling the air hammer 20 to the fuel injector 10, a user may operate the air hammer 20. Forces exerted by the air hammer 20 may be transferred to the fuel injector 10 (e.g., via elongated shaft 302 and fuel injector attachment adapter 342). In a preferred embodiment, a bi-directional air hammer 20 is used to exert pulling forces, which may be transferred to the fuel injector 10. It is contemplated that the fuel injector 10 may thereby be dislodged from the engine (e.g., via vibrational motion from the assembly 300).

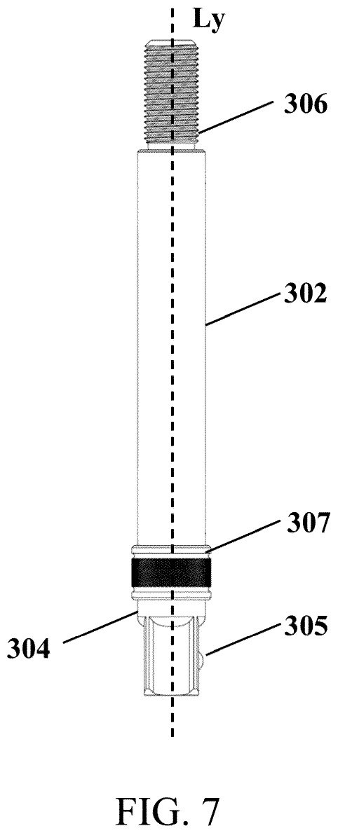

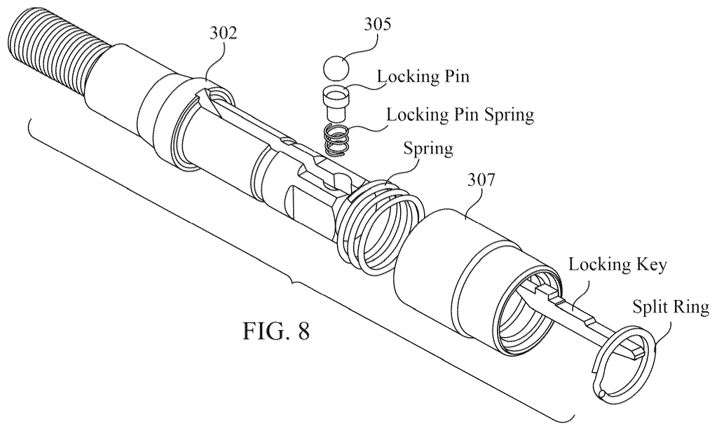

As noted above, the assembly 300 may be configured to allow for a quick disconnect (e.g., accelerated attachment and detachment) of the elongated shaft 302 from the fuel injector attachment adapter 342. As seen in FIGS. 7 and 8, the second end 306 of the elongated shaft 302 may comprise a threaded portion with external threads configured to removably couple to an air hammer 20, and the first end 304 may comprise a drive (e.g., square drive, hexagonal drive, etc.) configured to be received by a complementary aperture 352 of the fuel injector attachment adapter 342. The elongated shaft 302 may further comprise a detent ball 305 at or near its first end 304. The detent ball 305 may at least partially extend/protrude outwardly from the elongated shaft 302 such that it may be received by and secured within an aperture 353 in a sidewall of the fuel injector attachment adapter 342. The elongated shaft may further comprise a release collar 307 axially slidable relative to the elongated shaft 352. The release collar 307 may be movable between a first position and a second position, wherein the first position correlates to a locked position in which the elongated shaft 302 is removably coupled to the fuel injector attachment adapter 342, and the second position correlates to a releasable position in which the elongated shaft 302 may be released from to the fuel injector attachment adapter 342.

As can be appreciated by FIGS. 7 and 8, when the collar 307 is slidably retracted and moved to a releasable position, the detent ball 305 may be retracted and the elongated shaft 302 may be released from the fuel injector attachment adapter 342. For example, the detent ball 305 may be attached to a locking pin and locking pin spring (collectively referred to herein as the detent ball assembly), and the collar 307 may be attached to a locking key which is further attached to the detent ball assembly. As the collar 307 is slidably retracted and moved to a releasable position, the locking key may be configured to drop/retract the detent ball assembly into the shaft, thus allowing the elongated shaft 302 to be slidably released from to the fuel injector attachment adapter 342, as the detent ball 305 is no longer received by and secured within an aperture 353 in a sidewall of the fuel injector attachment adapter 342.

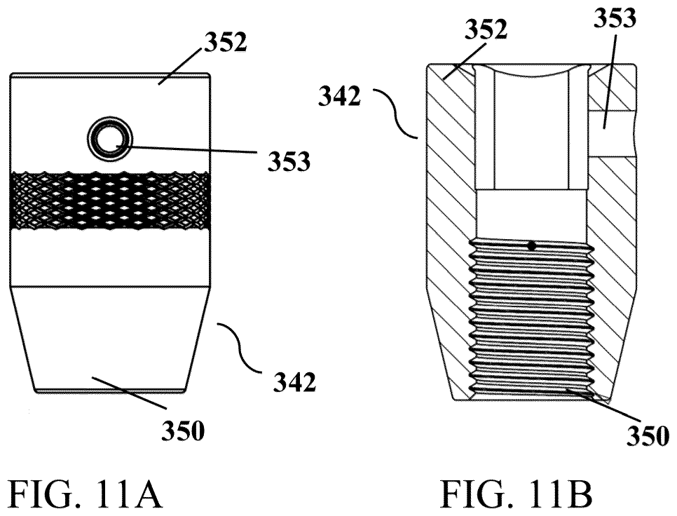

In some embodiments, as seen in FIGS. 11A, 11B, and 12, the fuel injector attachment adapter 342 may comprise a first aperture 350 which may have internal threads that complement a threaded portion of the fuel injector 10 such that the fuel injector attachment adapter 342 may be removably coupled to the fuel injector 10. The fuel injector attachment adapter 342 may further comprise a second aperture 352 which may be shaped to complement the drive of the elongated shaft 302 to removably couple the elongated shaft 302 to the fuel injector attachment adapter 342. The fuel injector attachment adapter 342 may further comprise an aperture 353 in a sidewall configured to receive the detent ball 305 of the elongated shaft 302 to securely couple of the elongated shaft 302 to the fuel injector attachment adapter 342. Put differently, the detent ball 305 may lock into the aperture 353 when the elongated shaft 302 is properly aligned and connected with the fuel injector attachment adapter 342.

As detailed above, it is contemplated that when the release collar 307 is retracted (e.g., moved to a second position), the release collar 307 is configured to release the detent ball 305 from the aperture 353 such that the elongated shaft 302 may be released from the fuel injector attachment adapter 342 (see FIG. 7). It is therefore contemplated that the above allows for a quick connection between (and disconnection of) the elongated shaft 302 from the fuel injector attachment adapter 342.

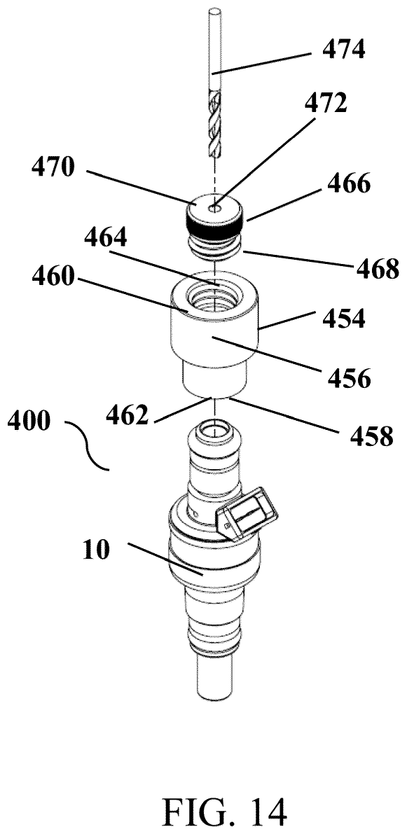

In a fourth embodiment, a fourth fuel injector removal assembly 400 is configured to remove a fuel injector 10 from an engine. As seen in FIG. 14, the assembly 400 is first configured to prepare the fuel injector 10 for removal. This fourth embodiment is advantageous for situations in which there are no means to easily couple to a fuel injector, so the fuel injector must be modified in order to effectuate its removal. The assembly 400 comprises an alignment device 454, a drill bushing 466, and a tap bushing (not shown).

The alignment device 454 has a body 456 (e.g., metal, metal alloy, plastic, polymer, ceramic, composite material, etc.) with a longitudinal axis running from a first face 458 to a second face 460. It is contemplated for the body 456 to be cylindrical in shape with a circular cross-section when viewed along the longitudinal axis. Other cross-sectional shapes can be used, such as triangular, square, hexagonal, etc. Each of the first face 458 and the second face 460 forms a planar terminus, but any one or combination of the faces 458, 460 need not be planar in shape.

The alignment device 454 is configured to be positioned over on the fuel injector 10, particularly the stem-like member 14 and/or knob-like member 16 of the fuel injector 10, so as to align or register itself with the fuel injector 10. The alignment device 454 comprises a first aperture 462 at the first face 458. The first aperture 462 may be a constituent of a through hole extending throughout the body 456 of the alignment device 454 (e.g., extending from the first face 458 to the second face 460), and is configured to receive the fuel injector 10.

The alignment device 454 further comprises a second aperture 464 at the second face 460. The second aperture 464 may be a constituent of the through hole extending throughout the body 456 of the alignment device 454, and is configured to receive the drill bushing 466. The second aperture 464 may have internal threads that complement a threaded portion of the drill bushing 466, as will be described in more detail below, such that the alignment device 454 may be removably coupled to the drill bushing 466.

In operation, the alignment device is 454 is positioned over the fuel injector 10 (e.g., members 14 and/or 16) such that the first face 458 abuts the fuel injector 10. The alignment device 454 is positioned such that apertures 462, 464 properly align with the central portion or the center of the fuel injector 10 (e.g., members 14 and/or 16). Being properly aligned means that the apertures 462, 464 overly and are coaxial with the fuel injector 10.

It is contemplated for the size, shape, and ornamentation of the first face 458 and/or the first aperture 464 to be selected so as to complement the ornamentation of the fuel injector 10 (particularly members 14 and/or 16). The greater the match of surface ornamentations between the first face 458 and/or the first aperture 464 and the fuel injector 10, the more effective the alignment device 454 will be in assisting in the removal of the fuel injector 10 from the engine.

As can be appreciated from the above, the fuel injector 10 has members 14 and/or 16 that fit into the first aperture 462 and may mechanically engage (e.g., abut against) with the first face 458 when the alignment device 454 is positioned over the fuel injector 10. It is contemplated that the first aperture 462 has an inner diameter that is equal to or greater than the portion of the fuel injector 10 over which the alignment device 454 will be positioned over. In some embodiments, the first aperture 462 has an inner diameter that is only slightly greater than the portion of the fuel injector 10 over which the alignment device 454 will be positioned over.

After the alignment device 454 is in position, a user may couple the drill bushing 466 to the alignment device 454. The drill bushing 466 (e.g., metal, metal alloy, plastic, polymer, ceramic, composite material, etc.) has a longitudinal axis running from a first end 468 to a second end 470. It is contemplated for the drill bushing 466 to be cylindrical in shape with a circular cross-section. Other cross-sectional shapes can be used, such as triangular, square, hexagonal, etc. Each of the first end 468 and the second end 470 forms a planar terminus, but any one or combination of the end 468, 470 need not be planar in shape.

As described above, the drill bushing 466 is configured to removably couple to the alignment device 454. The first end 468 may comprise a threaded portion with external threads. It is contemplated that the threaded portion of the first end 468 may complement internal threads of the second aperture 464 of the alignment device 454 to removably couple the drill bushing 466 to the alignment device 454.

The drill bushing 466 further comprises a drill insertion aperture 472. The drill insertion aperture 472 may be formed as a through hole extending throughout the drill bushing 466 (e.g., extending from the first end 468 and to the second end 470). It is contemplated that the drill bushing 466 is positioned such that the drill insertion aperture 472 properly aligns with apertures 462, 464 of the alignment device 454 (and with the central portion or the center of the fuel injector 10). Being properly aligned means that the drill insertion aperture 472 overlies and is coaxial with apertures 462, 464 of the alignment device 454 (and with the fuel injector 10).

After the drill bushing 466 is in place, the alignment device 454 and drill bushing 466 work together and may be used as a guide to assist a user in location and placement of a drill bit or similar tool 474 when attempting to drill into the fuel injector 10. A user uses the drill insertion aperture 472 to insert the drill bit or other tool there-through to perform the required work for drilling into the fuel injector 10. It is contemplated that the drill insertion aperture 472 is configured to ensure that a drill bit or other tool that is too large is not used.

After a user successfully drills into the fuel injector 10, the drill bushing 466 may be removed from the alignment device 454, and a tap bushing may then be coupled to the alignment device 454.

The tap bushing (not shown) is configured to be removably coupled to the alignment device 454. The tap bushing may be substantially similar to the drill bushing 466. For example, the tap bushing comprises a tap insertion aperture. The tap insertion aperture may be formed as a through hole extending throughout the tap bushing. It is contemplated that the tap bushing is positioned such that the tap insertion aperture properly aligns with apertures 462, 464 of the alignment device 454 (and with the central portion or the center of the fuel injector 10). It is further plated that the tap bushing is positioned such that the tap insertion aperture properly aligns with a hole drilled into the fuel injector via the drill bit or other tool. Being properly aligned means that the tap insertion aperture overlies and is coaxial with apertures 462, 464 of the alignment device 454 (and with drilled hole).

After the tap bushing is in place, the alignment device 454 and tap bushing work together and may be used as a guide to assist a user in location and placement of a tap bit or similar tool when attempting to tap into the fuel injector 10. Tapping means that threads area created within the fuel injector 10 to effectuate eventual removal of the fuel injector 10. A user uses the tap insertion aperture to insert the tap bit or other tool there-through to perform the required work for tapping the fuel injector 10. It is contemplated that the tap insertion aperture is configured to ensure that a drill bit or other tool that is too large is not used.

After a user successfully taps into the fuel injector 10, both the alignment device 454 and the tap bushing may be removed from the fuel injector 10.

With conventional methods and apparatuses, as the user employs a drill and/or tap, the bit can wander (i.e. move laterally) and misalign from central portion or center of the fuel injector 10. Wandering is undesirable because it can make it more difficult to remove the fuel injector 10 from the engine. In addition, the wandering drill bit can make contact with and damage other features of the fuel injector and/or engine. The inventive methods and apparatuses disclosed herein, however, can involve inserting a drill bit through the aligned or co-registered insertion apertures so as to maintain proper alignment before, during, and/or after actuation of the bits.

After the fuel injector is tapped, as discussed above with respect to the second and third embodiments, adapter 232 may be removably coupled to the fuel injector 10 (e.g., protrusion 238 may comprise a threaded portion with external threads which may complement the internal threading formed by the tap bit of this embodiment), and an elongated shaft 202 may be removably couple to the adapter 232. The aperture 240 of the adapter 232 may have internal threads that complement a threaded portion of the first end of the elongated shaft 202 to removably couple the elongated shaft 202 to the adapter 232. In an alternative embodiment, the aperture 240 may be shaped to complement a drive of the first end of the elongated shaft 202 to removably couple the elongated shaft 202 to the adapter 232. It is contemplated that this embodiment allows for a quick disconnect of the elongated shaft 202 from the adapter 232. The elongated shaft 202 is further configured to removably couple to the air hammer 20, such that the air hammer 20 is in indirect contact with the fuel injector 10. Accordingly, a user may operate the air hammer 20, and forces exerted by the air hammer 20 may be transferred to the fuel injector 10 (e.g., via elongated shaft 202 and adapter 232). In a preferred embodiment, a bi-directional air hammer 20 is used to exert pulling forces, which may be transferred to the fuel injector 10. It is contemplated that the fuel injector 10 may thereby be dislodged from the engine.

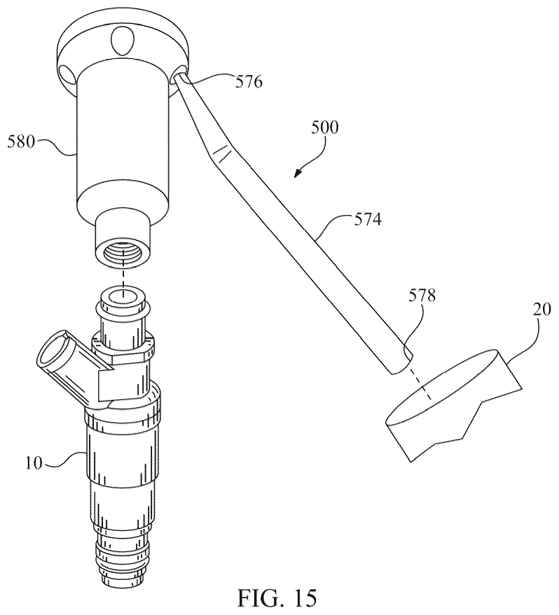

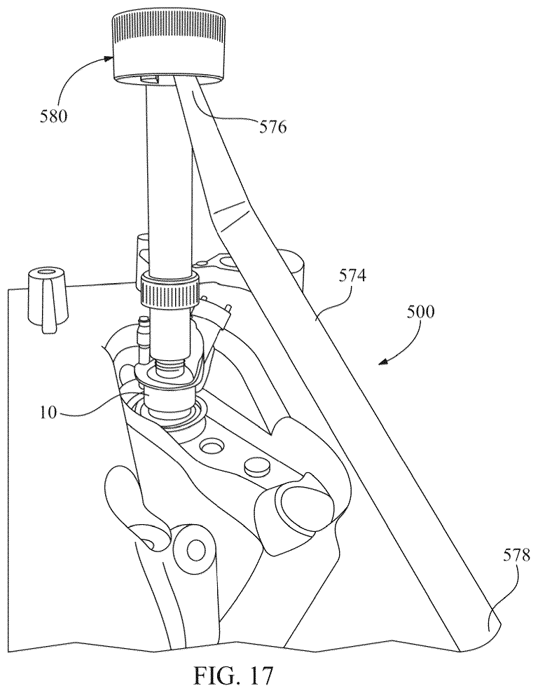

In a fifth embodiment, a fifth fuel injector removal assembly 500 is configured to remove a fuel injector 10 from an engine. As seen in FIGS. 15 and 17, assembly 500 comprises a striking rod 574 configured to removably couple to the air hammer 20, and a struck piece 580 configured to be removably coupled to the fuel injector 10 (e.g., either directly or indirectly, such as via an elongated shaft). In operation, the striking rod is 574 is configured to strike the struck piece 580 (via the forces exerted by the air hammer 20), thus loosening the fuel injector 10 from its secured position. This fifth embodiment is advantageous for situations in which the fuel injector 10 is in a difficult to access position, such that an air hammer 20 may not be easily coupled to the fuel injector 10.

The striking rod 574 is an elongated, rigid material e.g., metal, metal alloy, plastic, polymer, ceramic, composite material, etc.) with a longitudinal axis running from a first end 576 to a second end 578. The striking rod 574 may have any cross-sectional shape (e.g., triangular, square, hexagonal) so long as it extends in the longitudinal direction. Each of the first end 576 and the second end 578 may form a planar terminus, but any one or combination of the ends 576, 578 need not be planar in shape. The first end 576 may optionally be angled such that it may more easily strike the struck piece 580 in desired positions, as described below.

The second end 578 of the striking rod 574 is configured to removably couple to the air hammer 20. The second end 578 may comprise a threaded portion with external threads. It is contemplated that the threaded portion of the second end 578 may complement threads (e.g., internal or female threads) of a threaded aperture of the air hammer 20 to removably couple the striking rod 574 to the air hammer 20. However, any one of the second end 578 of the striking rod 574 or the aperture of the air hammer 20 can have a locking-pin, detent, magnet, or any other suitable coupling mechanism to secure the striking rod 574 to the air hammer 20. Another option is for the aperture to be an opening configured to receive a complementary drive (e.g., square drive, hexagonal drive, etc.) of the second end 578.

In operation, the first end 576 of the striking rod 574 is configured to be driven by the air hammer 20 to strike the struck piece 580.

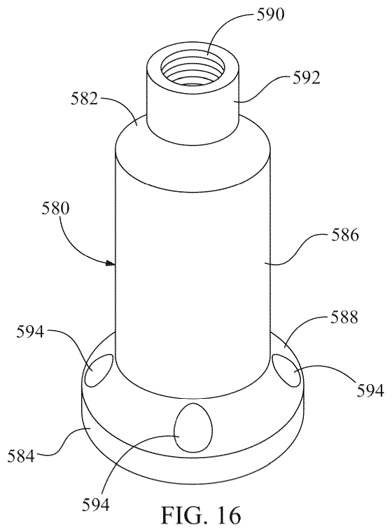

As seen in FIG. 16, the struck piece 580 (e.g., metal, metal alloy, plastic, polymer, ceramic, composite material, etc.) may have a body 586 attached to a base 588, wherein the base 588 is attached to the body 586 at the second end 584. It is contemplated for the body 586 to be cylindrical in shape with a circular cross-section. Other cross-sectional shapes can be used, such as triangular, square, hexagonal, etc. The struck piece 580 may have an aperture 590 at the first end 582. The aperture 590 may be a bore hole and is configured to receive the fuel injector 10. As described above, the fuel injector 10, particularly knob-like member 16, may have a threaded such that an apparatus with complementary threads may be removably coupled to the member 16. Accordingly, the aperture 590 may have internal threads that complement a threaded portion of the fuel injector 10 such that the struck piece 580 may be removably coupled to the fuel injector 10.

In some embodiments, the struck piece 580 may have a protrusion 592 at or near the first end 582. The protrusion 592 extends in or substantially in the Ly direction. In such embodiments, the protrusion 592 may comprise the aperture 590.

It is contemplated that the base 588 may extend radially outward such that the base has a greater diameter than the body 586. This feature is advantageous as it provides an area for a user to strike the struck piece 580 with the striking rod 574.

The base 588 may comprise a plurality of indents 594. The indents 594 are configured to inform a user should strike the struck piece 580 with the striking rod 574. It is contemplated that the indents 594 are configured to prevent the first end 582 of the striking rod 574 from sliding off of the struck piece 580 during operation. For example, it is contemplated that the first end 582 of the striking rod 574 may be positioned within the indent(s) 594 during operation.

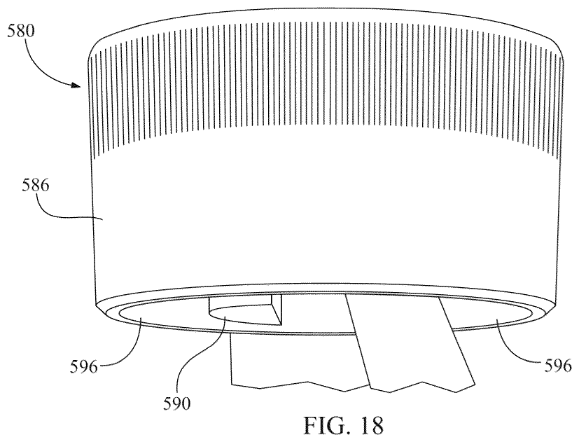

As seen in FIG. 18, the struck piece 580 (e.g., metal, metal alloy, plastic, polymer, ceramic, composite material, etc.) may have a body 586. It is contemplated for the body 586 to be cylindrical in shape with a circular cross-section. Other cross-sectional shapes can be used, such as triangular, square, hexagonal, etc. The struck piece 580 may have an aperture 590 configured to receive the fuel injector 10. As described above, the fuel injector 10, particularly knob-like member 16, may have a threaded such that an apparatus with complementary threads may be removably coupled to the member 16. Accordingly, the aperture 590 may have internal threads that complement a threaded portion of the fuel injector 10 such that the struck piece 580 may be removably coupled to the fuel injector 10. Alternatively, the aperture 590 may be configured to attach to an elongated shaft that may attached (indirectly or directly) to the fuel injector 10, as described in the above embodiments. Accordingly, the aperture 590 may have internal threads that complement a threaded portion of an elongated shaft such that the struck piece 580 may be removably coupled to an elongated shaft.

The struck piece 580 may comprise at least one groove 596. The groove 596 is configured to inform a user should strike the struck piece 580 with the striking rod 574. It is contemplated that the groove 596 may further be configured to prevent the first end 582 of the striking rod 574 from sliding off of the struck piece 580 during operation. For example, it is contemplated that the first end 582 of the striking rod 574 may be positioned within the groove 596 during operation.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A method of using a fuel injector removal assembly, wherein the assembly comprises a fuel injector attachment adapter, an elongated shaft, and an air hammer, the method comprising:
coupling the fuel injector attachment adapter to a fuel injector;
coupling a first end of the elongated shaft to the fuel injector attachment adapter;
coupling the air hammer to a second end of the elongated shaft; and
actuating the air hammer.

2. The method of claim 1, wherein the fuel injector attachment adapter has a first face and a second face, wherein the first face has a first aperture and the second face has a second aperture.

3. The method of claim 2, wherein the first aperture is threaded, and wherein the step of coupling the fuel injector attachment adapter to the fuel injector involves inserting a threaded portion of the fuel injector into the first aperture of the fuel injector attachment adapter.

4. The method of claim 2, wherein the second aperture is threaded and the first end of the elongated shaft comprises a threaded portion, and wherein the step of coupling the first end of the elongated shaft to the fuel injector attachment adapter involves inserting the threaded portion of the elongated shaft into the second aperture of the fuel injector attachment adapter.

5. The method of claim 2, wherein the first end of the elongated shaft comprises a drive and the second aperture of the fuel injector attachment adapter comprises a complementary opening, and wherein the step of coupling the first end of the elongated shaft to the fuel injector attachment adapter involves inserting the drive of the elongated shaft into the second aperture of the fuel injector attachment adapter.

6. The method of claim 5, wherein the elongated shaft further comprises a detent ball configured to be received by an aperture in a sidewall of the fuel injector attachment adapter to secure the elongated shaft to the fuel injector attachment adapter.

7. The method of claim 6, wherein the elongated shaft further comprises a release collar axially slidable relative to the elongated shaft, wherein the release collar is configured to release the elongated shaft from the fuel injector attachment adapter when retracted.

8. The method of claim 1, wherein the fuel injector attachment adapter has a first face and a second face, wherein a protrusion extends from the first face and the second face has an aperture.

9. The method of claim 8, wherein the protrusion has a threaded portion, and wherein the step of coupling the fuel injector attachment adapter to the fuel injector involves inserting the protrusion into a complementary threaded portion of the fuel injector.

10. The method of claim 8, wherein the aperture is threaded and the first end of the elongated shaft comprises a threaded portion, and wherein the step of coupling the first end of the elongated shaft to the fuel injector attachment adapter involves inserting the threaded portion of the elongated shaft into the aperture of the fuel injector attachment adapter.

11. The method of claim 1, wherein the air hammer is a bi-directional air hammer.

12. A method of using a fuel injector removal assembly, wherein the assembly comprises a striking member, a struck piece, and an air hammer, the method comprising:
coupling the struck piece to a fuel injector;
coupling a first end of the striking rod to the air hammer; and
actuating the air hammer such that a second end of the striking rod is driven against the struck piece.

13. The method of claim 12, wherein the struck piece comprises:
a body having a first end and a second end;
an aperture formed at the first end; and
a base attached to the second end of the body.

14. The method of claim 13, wherein the aperture is threaded, and wherein the step of coupling the struck piece to the fuel injector involves inserting a threaded portion of the fuel injector into the aperture of the struck piece.

15. The method of claim 13, wherein the base extends radially outward such that the base has a greater diameter than the body, and wherein the base has a plurality of indents, and wherein the step of actuating the air hammer such that the second end of the striking rod is driven into the struck piece involves driving the second end of the striking rod into the indents of the base.

16. The method of claim 12, wherein the air hammer is a bi-directional air hammer.

17. A method of using a fuel injector removal assembly, wherein the assembly comprises a striking member, a struck piece, an elongated shaft, and an air hammer, the method comprising:
coupling the struck piece to a first end of the elongated shaft;
coupling a second end of the elongated shaft to a fuel injector;
coupling a first end of the striking rod to the air hammer; and
actuating the air hammer such that a second end of the striking rod is driven against the struck piece.

18. The method of claim 17, wherein the struck piece comprises a body and an aperture formed in the body, wherein the step of coupling the struck piece to the first end of the elongated shaft involves inserting a portion of the elongated shaft into the aperture of the struck piece.

19. The method of claim 18, wherein the body has at least one groove formed therein, and wherein the step of actuating the air hammer such that the second end of the striking rod is driven into the struck piece involves driving the second end of the striking rod into the at least one groove.

20. The method of claim 17, wherein the air hammer is a bi-directional air hammer.
